(19) United States
(12) Patent Application Publication
(10) Pub. No.: US 2024/0027726 A1
(43) Pub. Date: Jan. 25, 2024

(54) LENS DRIVING ACTUATOR

(71) Applicant: LG INNOTEK CO., LTD., Seoul (KR)

(72) Inventors: Jung In JANG, Seoul (KR); Jae Wook KWON, Seoul (KR); Tae Min HA, Seoul (KR)

(21) Appl. No.: 18/025,012

(22) PCT Filed: Sep. 7, 2021
(86) PCT No.: PCT/KR2021/012148

§ 371 Date: Mar. 7, 2023

(30) Foreign Application Priority Data
Sep. 8, 2020 (KR) 10-2020-0114475
Sep. 8, 2020 (KR) 10-2020-0114476

(51) Int. Cl. G02B 7/09; G02B 27/64; H04N 23/68; H04N 23/55

(52) U.S. Cl. CPC G02B 7/09; G02B 27/64; H04N 23/687; H04N 23/55

(57) ABSTRACT

An actuator according to an embodiment of the present invention comprises: a magnet; a plurality of position sensors arranged to face the magnet; and a control unit which is connected to each of the plurality of position sensors and receives a signal input to detect the position of the magnet.

### TECHNICAL FIELD

The present invention relates to a lens driving actuator, and more particularly, to an actuator for detecting a position of a magnet using a plurality of position sensors and a camera module including the same.

### BACKGROUND ART

A camera module comprises an actuator that performs auto focusing or zoom function for magnification and focusing, or an actuator for handshake correction (OIS). To drive the actuator, the position of the magnet disposed in a lens barrel is detected using a Hall sensor to find the position of a lens, and a control signal is applied to a driving coil according to the position of the detected magnet to operate the actuator.

As the need for high-performance zoom function and high accuracy of the camera module increases, the required stroke length is getting longer and, at the same time, miniaturization of the camera module must be implemented, so there is a need to develop a technology capable of miniaturizing while increasing the stroke length.

### DETAILED DESCRIPTION OF THE INVENTION

### Technical Subject

A technical problem to be solved by the present invention is to provide an actuator for detecting a position of a magnet using a plurality of position sensors and a camera module including the same.

### Technical Solution

In order to solve the above technical problem, an actuator according to an embodiment of the present invention comprises: a magnet; a plurality of position sensors being disposed to face the magnet; and a control unit being connected to each of the plurality of position sensors to receive a signal and detect the position of the magnet.

In addition, the control unit may detect the position of the magnet using a signal being inputted from any one of the plurality of position sensors.

In addition, the control unit may change the position sensor being used to detect the position of the magnet with respect to a first position of the magnet.

In addition, the control unit, when the magnet moves in a first movement direction from the first position, a position sensor being located in the first movement direction among the plurality of position sensors is used to detect the position of the magnet, and when the magnet moves from the first position to a second movement direction opposite to the first movement direction, a position sensor being located in the second movement direction among the plurality of position sensors may be used to detect the position of the magnet.

In addition, the plurality of position sensors may comprise a first position sensor and a second position sensor spaced apart from each other in a first direction of the magnet.

In addition, the first position sensor and the second position sensor may be spaced apart from each other by a predetermined distance in a movement direction of the magnet.

In addition, the control unit may change the position sensor being used to detect the position of the magnet with respect to a point where the signal strength being inputted from the first position sensor or the second position sensor is 0.

In addition, the control unit may change the position sensor used to detect the position of the magnet with respect to the center point of the inflection point of the slope of the signal size of the first position sensor and the inflection point of the signal size of the second position sensor.

In addition, the control unit may detect the position of the magnet using a relationship between a signal of the first position sensor and a signal of the second position sensor.

In addition, the control unit may detect the position of the magnet using a linear function being derived from a relationship between a signal of the first position sensor and a signal of the second position sensor.

In addition, the linear function may be a first order function being derived from the trigonometric relationship between a signal of the first position sensor and a signal of the second position sensor and the phase difference between a signal of the first position sensor and a signal of the second position sensor.

In addition, the control unit may detect the position of the magnet using a first value 0 being derived from a signal of the first position sensor and a signal of the second position sensor through the linear function.

In addition, the control unit may be connected to each of the first position sensor and the second position sensor to receive signals.

In addition, the first position sensor and the second position sensor may be located to be spaced apart from the magnet in a first direction of the magnet.

In addition, the first position sensor and the second position sensor may be spaced apart from each other by a predetermined distance in a movement direction of the magnet.

In addition, the first position sensor and the second position sensor may be located on the same line parallel to the movement direction of the magnet.

In order to solve the above technical problem, the camera module according to an embodiment of the present invention comprises: a lens barrel; a magnet being disposed in the lens barrel; a coil being disposed to face the magnet; a plurality of position sensors being disposed in the coil; a control unit being connected to each of the plurality of position sensors to receive a signal and detect a position of the magnet; a driving unit for applying a drive signal to the coil according to the control of the control unit to move the magnet in one direction.

In addition, the control unit may detect the position of the magnet using a signal being inputted from any one sensor among the plurality of position sensors.

In addition, the plurality of position sensors comprises a first position sensor and a second position sensor being disposed in the coil, and the control unit may detect the position of the magnet using a relationship between a signal of the first position sensor and a signal of the second position sensor.

In addition, the control unit may detect the position of the magnet using a linear function being derived from a relationship between a signal of the first position sensor and a signal of the second position sensor.

### Advantageous Effects

According to embodiments of the present invention, it is possible to selectively use only a necessary section using signals received from a plurality of position sensors, respectively. Through this, since a non-linear section is not used, actuator control performance can be improved by using a signal close to linear. Furthermore, in addition, linearity can be improved by using a linear function through a tangential operation in a non-linear section.

### BRIEF DESCRIPTION OF DRAWINGS

FIG. 1 is a block diagram of an actuator according to an embodiment of the present invention.

FIGS. 2 and 3 illustrate signal connection relationships between each position sensor and a control unit in an actuator according to an embodiment of the present invention.

FIGS. 4 and 5 schematically illustrate the arrangement of a magnet of an actuator and a plurality of position sensors according to an embodiment of the present invention.

FIG. 6 illustrates a comparative example of an actuator according to an embodiment of the present invention.

FIGS. 7 to 12 are views for explaining a process of detecting a position of a magnet using a plurality of position sensors of an actuator according to an embodiment of the present invention.

FIG. 13 is a block diagram of a camera module according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or arranged in “on (above)” or “below (under)” of each component, “on (above)” or “below (under)” means that it comprises not only the case where the two components are directly in contact with, but also the case where one or more other components are formed or arranged between the two components. In addition, when expressed as “on (above)” or “below (under)”, the meaning of not only an upward direction but also a downward direction based on one component may be comprised.

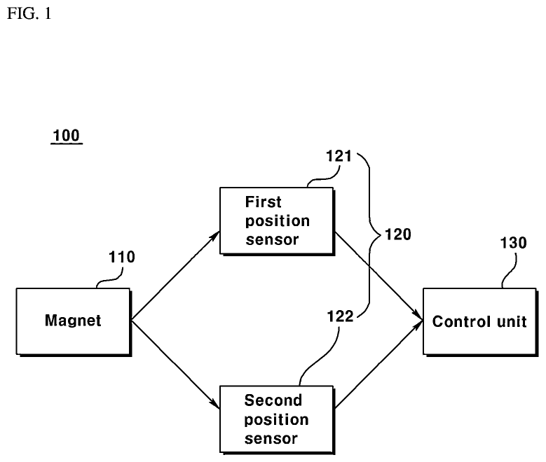

FIG. 1 is a block diagram of an actuator according to an embodiment of the present invention.

An actuator 100 according to an embodiment of the present invention comprises a magnet 110, a plurality of position sensors 120, and a control unit 130, a coil (not shown) and a memory (not shown) for storing a control algorithm or calibration information may be further comprised.

The magnet 110 may be a magnetic material being disposed in a lens barrel (not shown). The magnet 110 can move together with the lens barrel, and the position of the lens barrel can be known by detecting the position of the magnet 110. Here, one or more lenses may be coupled to the lens barrel, and a first group lens comprising a plurality of lenses may be coupled thereto. One or more magnets 110 may be disposed for each lens whose position is to be detected. A plurality of magnets 110 may be disposed to detect lens positions in a plurality of directions.

A plurality of position sensors 120 is disposed facing the magnet 110.

More specifically, a plurality of position sensors 120 are sensors for detecting the position of the magnet 110, and are disposed facing the magnet 110 in order to detect the position of the magnet 110. Here, the plurality of position sensors 120 may be Hall sensors. The Hall sensor is a sensor that detects a position by detecting a change in magnetism, and can detect the position of the magnet 110 using a change in magnetism being generated according to the movement of the position of the magnet 110.

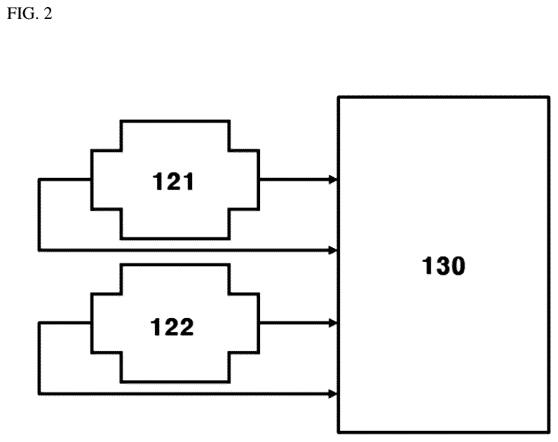

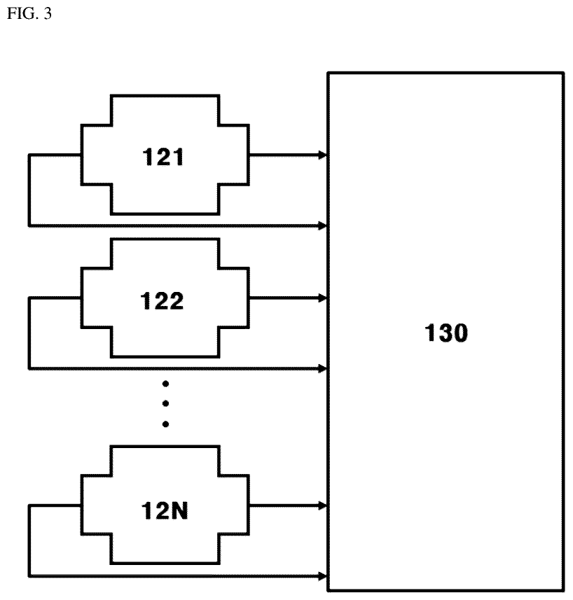

As shown in FIG. 2, a plurality of position sensors 120 may comprise a first position sensor 121 and a second position sensor 122. Two position sensors are described as a plurality of position sensors 120 as an example, but as shown in FIG. 3, it is natural that three or more position sensors can be used.

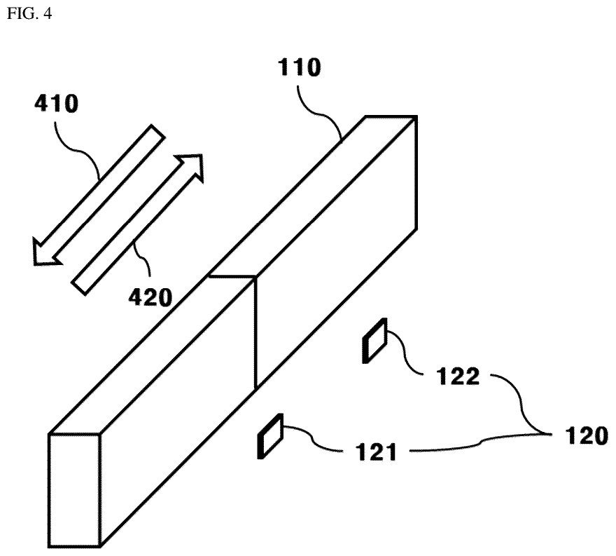

As shown in FIG. 4, the first position sensor 121 and the second position sensor 122 may be located being spaced apart from each other in a first direction of the magnet 110. Here, the first direction of the magnet 110 may be a direction perpendicular to one surface of the magnet 110 and a direction perpendicular to one surface being exposed to the outside of the magnet. The first position sensor 121 and the second position sensor 122 may be located being spaced apart from each other by a predetermined distance in a first direction facing the magnet 110. The distance between the magnet 110 and the first position sensor 121 and the second position sensor 122 may be set depending on the size of magnetism of the magnet 110, the specifications of the first position sensor 121 and the second position sensor 122, the size of the camera module, and the like. One of the first position sensor 121 and the second position sensor is located being spaced apart from each other in a first direction of the magnet 110, and the other one may be located being spaced apart from each other in a second direction of the magnet 110.

As shown in FIG. 4, the first position sensor 121 and the second position sensor 122 may be formed being spaced apart from each other by a predetermined distance in a movement direction 410 or 320 of the magnet 110. The first position sensor 121 and the second position sensor 122 are position sensors for detecting the position of the magnet 110 in a movement direction, and may be located being spaced apart from each other by a predetermined distance in a movement direction of the magnet 110. Here, the movement direction of the magnet 110 may be a direction in which the lens moves when performing the zoom function. When the magnet 110 moves in two or more directions, the first position sensor 121 and the second position sensor 122 may be located being spaced apart from each other in a direction in which the position of the magnet 110 is to be detected. The first position sensor 121 and the second position sensor 122 may be located on the same line as the movement direction of the magnet 110. The separation distance between the first position sensor 121 and the second position sensor 122 may be set depending on the movement distance of the magnet 110, the specifications of the magnet 110, the specifications of the first position sensor 121 and the second position sensor 122, and the size of the camera module.

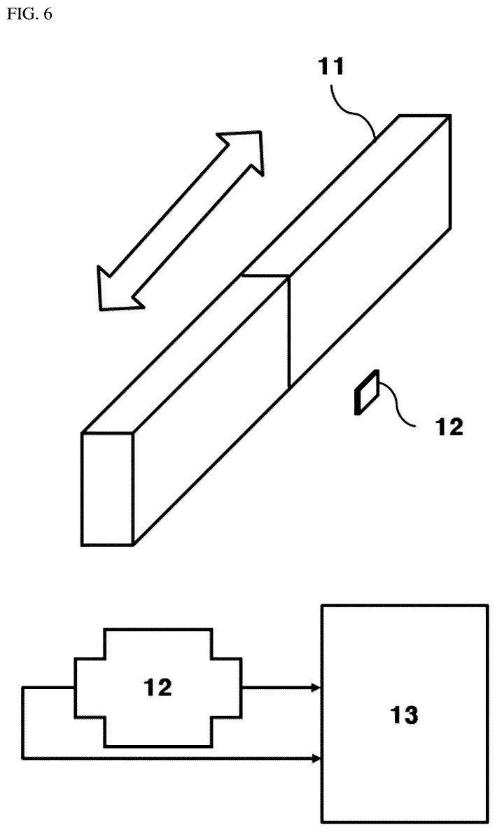

FIG. 6 is a comparative example of an actuator according to an embodiment of the present invention in which one position sensor 12 is disposed facing the magnet 11, and the position of the magnet 11 is detected by the one position sensor 12. The control unit 13 receives a signal from one position sensor 12 and controls the actuator. When only one position sensor is used, there is a problem in that in the case of long stroke control, since the control accuracy is low depending on the nonlinearity of the signal of the position sensor, so there is a limit in controlling of actuator accurately, and the size of the actuator increases, thereby increasing the overall size of the module. In contrast, an actuator according to an embodiment of the present invention is accurate and miniaturization becomes possible by using a plurality of position sensors 120.

The control unit 130 is connected to a plurality of position sensors 120 and receives signals to detect the position of the magnet.

More specifically, the control unit 130 is independently connected to each of the plurality of position sensors 120 and receives signals from the position sensors 120. As shown in FIG. 3, signals may be received from each of the position sensors of the plurality of position sensors 121, 122, and 12N being formed in an actuator. Here, the position sensor to which the control unit 130 receives a signal may be a position sensor that detects the position of the same magnet or a position sensor that may detect the position of different magnets. Even when there is a plurality of position sensors that detect the position of the same magnet, signals can be independently received from each position sensor. Each position sensor is connected with two channels, and the number of required channels can be multiplied depending on the number of position sensors. Depending on the number of available channels of the control unit 130, two or more position sensors may be inputted through the same signal line. More channels are required than in the case of inputting signals from the plurality of position sensors to the control unit 130 by connecting one signal line. For example, 4 channels are required for 4 Hall sensors by receiving signals independently compared to the case where, for example, two channels are needed for four Hall sensors.

The control unit 130 may be a driver IC. The control unit 130 may comprise at least one processor that processes a control algorithm stored in a memory for driving an actuator. Here, the control algorithm is an algorithm for detecting a position and position difference using a Hall sensor or a gyro sensor, which is a position sensor, and driving an actuator based on this, and the control unit 130 uses the corresponding algorithm to zoom, auto focus (AF), or handshake correction (OIS) functions. When driving by applying a control signal to the coil, the position of the magnet 110 can be adjusted by the magnetism between the coil and the magnet 110. Through this, zoom, autofocus, and handshake prevention functions can be performed.

The control unit 130 may detect the position of the magnet 110 using a signal being inputted from any one among a plurality of position sensors 120. Since the magnitude of a signal being inputted from the position sensor varies depending on the position of the magnet 110, the position of the magnet 110 can be detected using the magnitude of a signal being inputted from the position sensor. The magnitude of the signal of each position sensor may be several to hundreds of mV. The control unit 130 may detect the position of the magnet 110 by selectively using signals being inputted from a plurality of position sensors 120 for position information depending on a movement direction of the magnet 110. As described above, when the plurality of position sensors 120 comprise a first position sensor 121 and a second position sensor 122, the position of the magnet 110 may be detected using one of signals being inputted from the first position sensor 121 and the second position sensor 122.

The control unit 130 may change the position sensor being used to detect the position of the magnet 110 with respect to the first position of the magnet 110. The position of the magnet 110 may be used as a reference for selecting a position sensor being used to detect the position of the magnet 110.

With respect to a first position of the magnet 110, when the magnet 110 moves from the first position to a first movement direction 410, the position sensor 121 located in the first movement direction among a plurality of position sensors 120 is used to detect the position of the magnet 110, and when the magnet 110 moves from the first position to a second movement direction 420 opposite to the first movement direction, the position sensor 122 being located in the second movement direction among the plurality of position sensors 120 may be used to detect the position of the magnet 110. When the magnet 110 moves in a direction where one position sensor among the plurality of position sensors is located, since the position sensor located in the movement direction becomes closer to the magnet 110, and as the accuracy becomes higher than that of the other position sensors which is being moved away, a position sensor being used to detect the position of the magnet 110 may be changed according to which movement direction it is moved with respect to the first position.

Here, the first position of the magnet 110 may be a position where the center of the magnet coincides with the middle of a first position sensor 121 and a second position sensor 122. Magnets can be formed with N poles and S poles due to the nature of magnetic materials; the center of the N pole and the S pole may be the center of the magnet; the position where the center of the magnet coincides with the center of the first position sensor 121 and the second position sensor 122 is set as a first position; and a position sensor to be used to detect the position of the magnet 110 with respect to a first position may be selected.

The control unit 130 may change the position sensor being used to detect the position of the magnet 110 with respect to the point where the signal strength being inputted from the first position sensor 121 or the second position sensor 122 is 0. As described above, the magnitude of the signal of the position sensor varies depending on the position of the magnet, and the magnitude of the signal varies from positive to negative or from negative to positive depending on whether the position sensor is close to the N pole or S pole of the magnet. In selecting a position sensor being used to detect the position of the magnet 110, the control unit 130 may use a point where the signal strength being inputted from the first position sensor or the second position sensor is 0 as a reference. That is, a position sensor being used to detect the position of the magnet 110 may be selected based on a point where the magnitude of the signal of the first position sensor 121 is 0 or based on the point where the magnitude of the signal of the second position sensor 122 is 0.

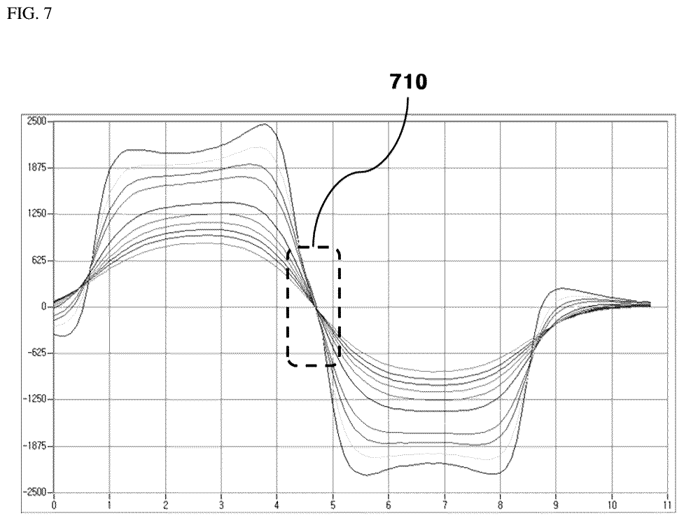

A signal being inputted from the position sensor 120 may be as shown in the graph of FIG. 7. In FIG. 7, the x-axis is the position value of the magnet 110, the initial position is 0, and the value increases as it is being moved. This corresponds to the stroke length. The y-axis is a magnet flux value, and the control unit 130 can convert the signal into a digital code and use it to detect the position of the magnet 110. In order to increase the accuracy of the position sensor, the position of the magnet 110 may be detected using a section 610 in which the signal value of the position sensor has linearity. Accuracy of detecting the position can be increased by using a section having linearity.

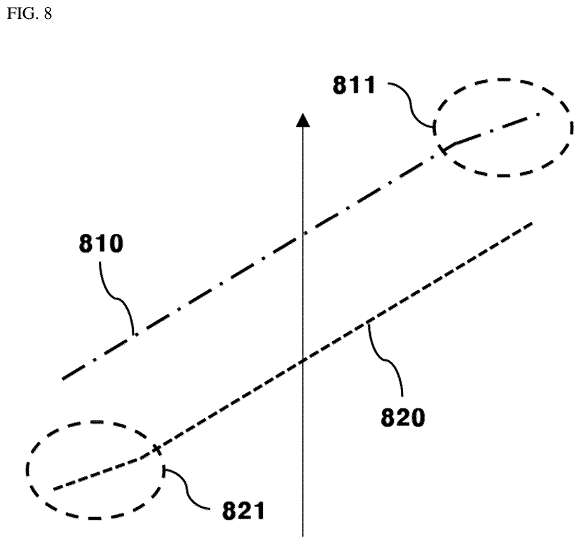

A section in which a signal has linearity may be different depending on the position of each position sensor. As shown in FIG. 8, the signal 810 of the first position sensor 121 has linearity during a predetermined section, and then a non-linear section 811 exists outside the predetermined section. In the case of using a signal in a non-linear section, control performance is degraded. The signal 820 of the second position sensor 122 also has linearity in a certain section, and a non-linear section 821 exists outside of this range. As shown in FIG. 8, linear sections of the first position sensor 121 and the second position sensor 122 may not coincide.

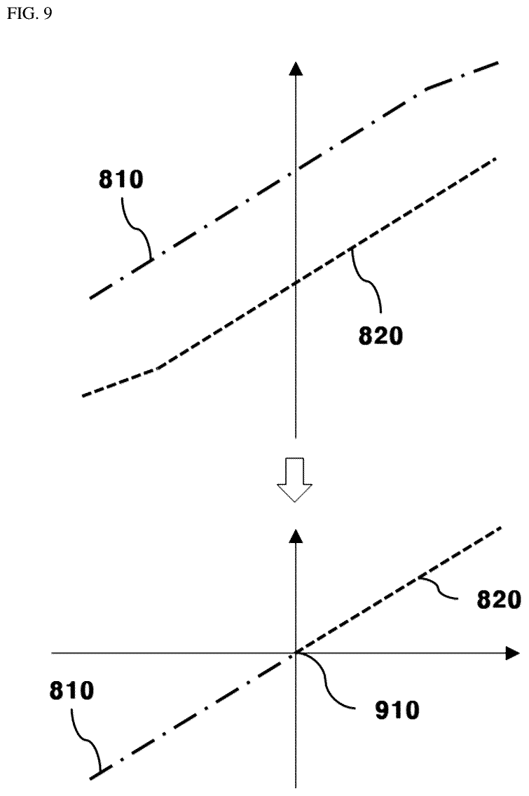

Since the control unit 130 independently receives signals from each of the plurality of position sensors 120, a sensor to be used to detect the position of the magnet 110 may be selected. Therefore, as shown in FIG. 9, the position of the magnet 110 can be detected by using a long linear section by using the sections having the linearity of the two sensors compared to the case in which one position sensor is used or the sum of signals from two position sensors is used.

The control unit 130 may change the position sensor being used to detect the position of the magnet 110 with respect to the center point of the inflection point of the slope of the signal magnitude of the first position sensor 121 and the inflection point of the signal magnitude of the second position sensor 122. As shown in FIG. 8, the position sensor being used to detect the position of the magnet 110 may be changed with respect to the center point of the point where the non-linear section of the first position sensor 121 starts and the point where the non-linear section of the second position sensor 122 starts. Here, the inflection point may be a position where the slope of the signal amplitude varies by more than a threshold value.

The reference point 910 for changing the sensor being used to detect the position of the magnet 110 is a switching point, and since the magnitude of the signal of the first position sensor 121 and the magnitude of the signal of the second position sensor 122 are different from each other at the corresponding position, the magnitudes of each other's signals or corresponding digital codes can be implemented with the same value by applying an offset at the reference point 910. The difference between the large value and the small value at the corresponding point may be set as an offset and applied. Through this, the control unit 130 can detect the position of the magnet 110 using a section having a wider linearity.

In this way, the position of the magnet can be detected in a wide range of linearity by detecting the position of the magnet 110 in one direction using a plurality of position sensors so that the controllable stroke length is increased and the control accuracy can also be increased. In addition, by using a plurality of position sensors rather than using one position sensor, when controlling with the same stroke length, a longer area of the magnet can be utilized, and due to this, the size of the magnet can be reduced, thereby enabling the miniaturization of a camera module.

The control unit 130 may detect the position of the magnet 110 by using the relationship between the signal of the first position sensor 121 and the signal of the second position sensor 122. The control unit 130 detects the position of the magnet 110 by using the signals of the first position sensor 121 and the second position sensor 122, and the relationship between the signal of the first position sensor 121 and the signal of the second position sensor 122 may be used.

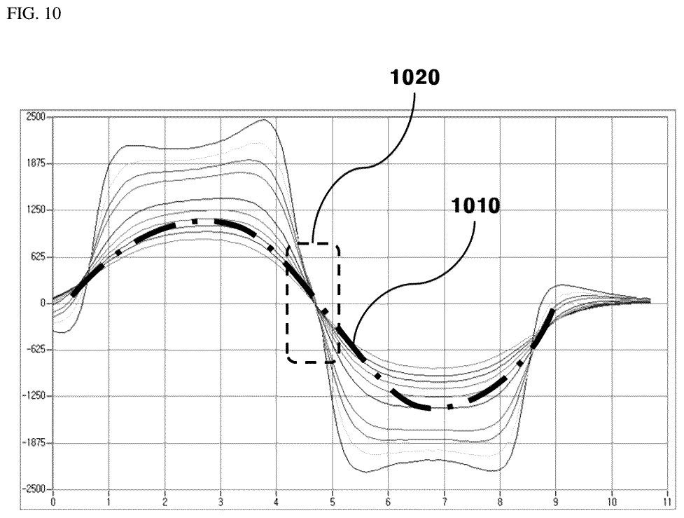

A signal being inputted from the first position sensor 121 or the second position sensor 122 may be as shown in the graph of FIG. 10. In FIG. 10, the x-axis is the position value of the magnet 110, the initial position is 0, and the value increases as it is being moved. This corresponds to the stroke length. The y-axis is a magnet flux value, and the control unit 130 can convert the signal into a digital code and use it to detect the position of the magnet 110. The magnitude of the signal being inputted from each position sensor varies depending on the position of the magnet 110, and the control unit 130 can detect the position of the magnet 110 using the magnitude of a signal being inputted from the position sensor. The magnitude of a signal of each position sensor may be several to hundreds of mV.

The signal of the position sensor may be in the form of a trigonometric function as shown in FIG. 10. Individual waveforms in the form of sine waves are signals from the position sensor at different distances from the magnet, and their amplitude or shape may vary depending on the distance from the magnet. When the position sensors 121 and 122 and the magnet 110 are formed to be spaced apart from each other by a certain distance, the position of the magnet 110 can be detected using a signal from the position sensor at the corresponding distance. At this time, the position of the magnet 110 may be detected by using the waveform 1010 of the entire section in the form of a sine wave.

Or, in order to increase the accuracy of the position sensor, the position of the magnet 110 may be detected using the section 1020 in which the signal value of the position sensor has linearity. Accuracy of position detection can be increased by using a section having linearity. However, the range of the section having linearity is limited, and when using a plurality of position sensors, the sections having linearity may be different from each other, and as a result, the section having linearity usable for detecting the position of the magnet 110 may be narrowed.

In order to increase the accuracy of magnet position detection, the control unit 130 may use the relationship between the signal of the first position sensor 121 and the signal of the second position sensor 122 not only in a linear section but also in a non-linear section.

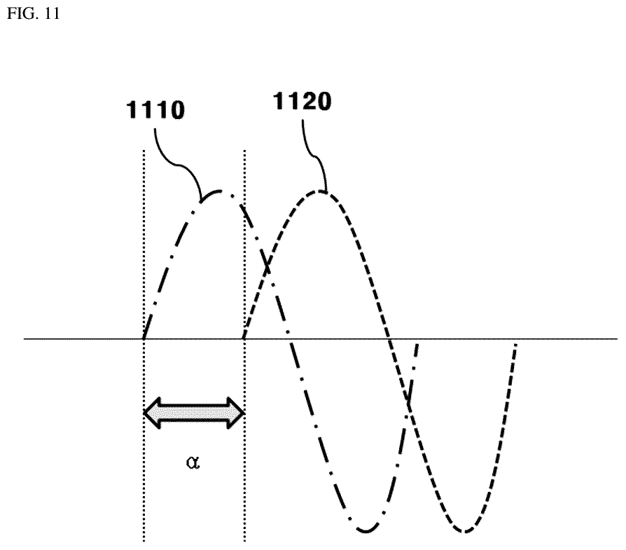

A signal of the first position sensor 121 and a signal of the second position sensor 122 may be as shown in FIG. 11. The signal 1110 of the first position sensor and the signal 1120 of the second position sensor have a relationship of sine and cosine functions, but have a phase difference a. Here, the phase difference a is a value that varies depending on the distance between the first position sensor 121 and the second position sensor 122, and is a value that is fixed depending on the position of a position sensor.

The control unit 130 may detect the position of the magnet using a linear function being derived from the relationship between the signal 1110 of the first position sensor and the signal 1120 of the second position sensor.

A linear function may be a linear function being derived from the trigonometric relationship between the signal 1110 of the first position sensor and the signal 1120 of the second position sensor and the phase difference between the signal of the first position sensor and the signal of the second position sensor. The accuracy in measuring the position of magnet can be improved by converting the relationship between the signal 1110 of the first position sensor and the signal 1120 of the second position sensor into a linear function.

The signal 1110 of the first position sensor and the signal 1120 of the second position sensor have the following relationship.

sensor1=sin(θ+α)

sensor2=cos(θ)

sensor1/sensor2=sin(θ+α)/cos(θ)=sin(α)+tan(θ)*cos(α) [Equation 1]

The following linear function can be derived from the above relationship using tangential operation.

θ=atan(sensor1/sensor2−sin(α)/cos(α))

OR

θ=atan 2(cos(α),sensor1/sensor2−sin(α)) [Equation 2]

That is, each signal can be converted into a function of Theta θ. The position of the magnet 110 can be detected in a section where it is changed into a linear function and the linear function maintains linearity.

The control unit 130 may detect the position of the magnet by using the first value being derived from the signal of the first position sensor and the signal of the second position sensor through the linear function.

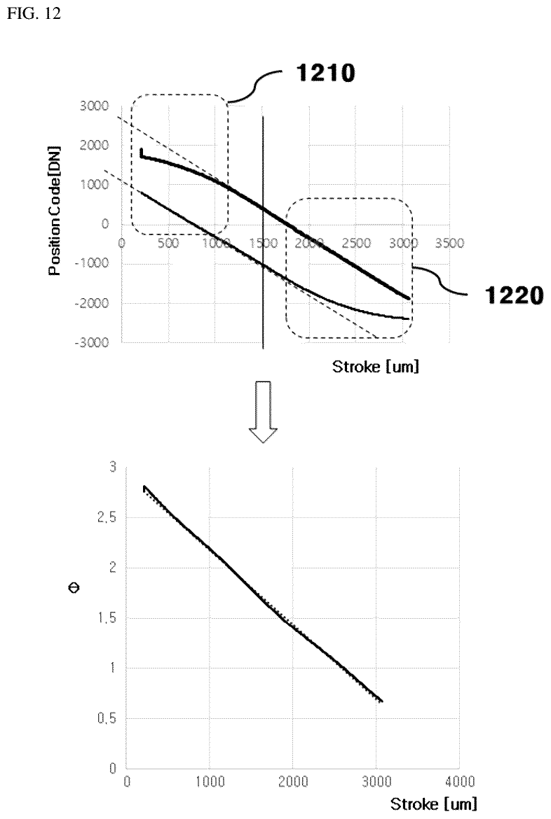

By using the linear function, as shown in FIG. 12, it is possible to use linearly up to the non-linear section of the signal of each position sensor. The signal of the first position sensor 121 may have non-linearity in a section of 710, and the signal of the second position sensor 122 may have a non-linearity in a section of 720. In the case of using a signal in a non-linear section, control performance is degraded. By using a linear function according to the relationship between the signals of two position sensors, not the signal of the position sensor, it can be seen that even the non-linear section can be used linearly as shown below in FIG. 12.

In this way, by detecting the position of the magnet 110 using a linear function according to the relationship between the signal of the first position sensor 121 and the signal of the second position sensor 122, the position of the magnet can be detected in a wide range of linearity, and the controllable stroke length is increased, thereby possibly increasing the control accuracy. In addition, by using a plurality of position sensors rather than using one position sensor, when controlling with the same stroke length, a longer region of the magnet can be utilized, and owing to this, since the size of the magnet can be reduced, miniaturization of the camera module becomes possible.

Each of the control unit 130 may be respectively connected to the first position sensor 121 and the second position sensor 122 to receive signals. The control unit 130 is independently connected to each of the first position sensor 121 and the second position sensor 122 and receives a signal. As shown in FIG. 2, signals may be received from each of the first position sensor 121 and the second position sensor 122 being formed in an actuator.

The control unit 130 may detect the position of the magnet 110 by using a signal being inputted from any one of the first position sensor 121 and the second position sensor 122. The control unit 130 may detect the position of the magnet 110 by selectively using a signal being inputted from the first position sensor 121 or the second position sensor 122 as for position information according to a movement direction of the magnet 110.

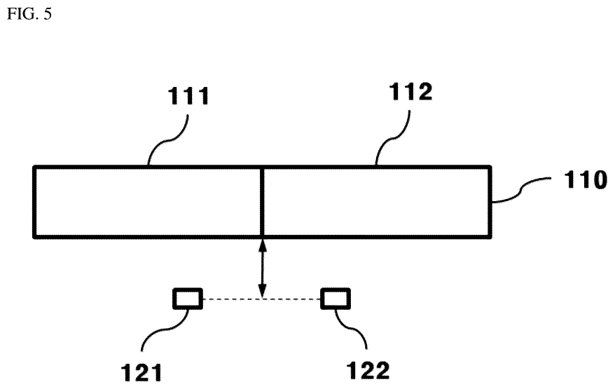

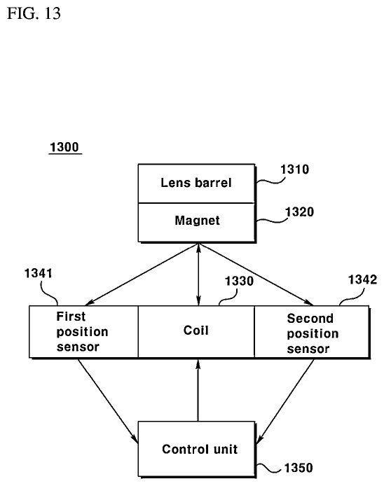

FIG. 13 is a block diagram of a camera module according to an embodiment of the present invention. Since a detailed description of each configuration of the camera module 1300 according to an embodiment of the present invention corresponds to a detailed description of each configuration of the actuator 100 of FIGS. 1 to 12 corresponding to each configuration, hereinafter, the overlapping descriptions will be omitted.

The camera module 1300 according to an embodiment of the present invention comprises: a lens barrel 1310; a magnet 1320 being disposed in the lens barrel 1310; a coil 1330 being disposed to face the magnet 1320; a plurality of position sensors 1341 and 1342 being disposed in the coil 1330; and a control unit 1350 being connected to the plurality of position sensors 1341 and 1342, respectively, to receive signals and detect the position of the magnet 1320, and apply a control signal to the coil 1330 according to the position of the magnet 1320 so as to move the magnet 1320 in one direction.

Here, the control unit 1350 may detect the position of the magnet 1320 using a signal being inputted from any one of the plurality of position sensors 1341 and 1342.

The plurality of position sensors 1341 and 1342 may comprise a first position sensor 1341 and a second position sensor 1342. At this time, the control unit 1350 may detect the position of the magnet 1320 by using the relationship between the signal of the first position sensor 1341 and the signal of the second position sensor 1342.

The control unit 1350 may detect the position of the magnet 1320 by using a linear function being derived from the relationship between the signal of the first position sensor 1341 and the signal of the second position sensor 1342.

A modified embodiment according to the present embodiment may comprise some configurations of each embodiment and some configurations of other embodiments. That is, the modified embodiment comprises a first embodiment, but may omit some configurations of the first embodiment and comprise some configurations of a second embodiment corresponding thereto. Or, the modified embodiment may comprise the second embodiment, but some configurations of the second embodiment may be omitted and some configurations of the first embodiment may be comprised.

Features, structures, effects, and the like described in the embodiments above are comprised in at least one embodiment, and are not necessarily limited to only one embodiment. Furthermore, the features, structures, effects, and the like illustrated in each embodiment can be combined or modified for other embodiments by those skilled in the art in the field to which the embodiments belong. Therefore, contents related to these combinations and modifications should be construed as being comprised in the scope of the embodiments.

Those skilled in the art related to the present embodiment will be able to understand that it may be implemented in a modified form within a range that does not deviate from the essential characteristics of the above description. Therefore, the disclosed methods are to be considered in an illustrative rather than a limiting sense. The scope of the present invention is presented in the claims rather than the foregoing description, and all differences within the equivalent scope will be construed as being comprised in the present invention.

1. An actuator comprising:
a magnet;
a plurality of position sensors being disposed facing the magnet; and
a control unit being connected to the plurality of position sensors and receiving signals to detect the position of the magnet,
wherein the control unit changes a position sensor being used to detect the position of the magnet with respect to a first position of the magnet.

2. The actuator according to claim 1,
wherein the control unit detects the position of the magnet by using a signal being inputted from any one of the plurality of position sensors.

3. The actuator according to claim 1,
wherein the plurality of position sensors includes a first position sensor and a second position sensor being disposed to be spaced apart in a first direction of the magnet,
wherein a signal of the first position sensor comprises a linear section and a non-linear section,
wherein a signal of the second position sensor comprises a linear section and a non-linear section, and
wherein the linear section of the first position sensor and the linear section of the second position sensor do not coincide.

4. The actuator according to claim 3,
wherein the control unit uses:
a position sensor located in the first movement direction among the plurality of position sensors to detect the position of the magnet when the magnet moves from the first position to a first movement direction; and
a position sensor located in the second movement direction among the plurality of position sensors to detect the position of the magnet when the magnet moves from the first position to a second movement direction opposite to the first movement direction.

5. The actuator according to claim 1,
wherein the plurality of position sensors includes a first position sensor and a second position sensor being disposed to be spaced apart in a first direction of the magnet.

6. The actuator according to claim 5,
wherein the first position sensor and the second position sensor are spaced apart from each other by a predetermined distance in a movement direction of the magnet.

7. The actuator according to claim 5,
wherein the control unit changes a position sensor being used to detect the position of the magnet with respect to a point where a signal strength being inputted from the first position sensor or the second position sensor is 0.

8. The actuator according to claim 5,
wherein the control unit changes a position sensor being used to detect the position of the magnet with respect to the center point of an inflection point of a slope of a signal magnitude of the first position sensor and an inflection point of a signal magnitude of the second position sensor.

9. The actuator according to claim 5,
wherein the control unit detects the position of the magnet by using a linear function being derived from the relationship between a signal of the first position sensor and a signal of the second position sensor.

10. The actuator according to claim 9,
wherein the linear function is a linear function being derived from a trigonometric relationship between a signal of the first position sensor and a signal of the second position sensor and the phase difference between a signal of the first position sensor and a signal of the second position sensor.

11. An actuator comprising:
a magnet;
a plurality of position sensors being disposed facing the magnet; and
a control unit being connected to the plurality of position sensors and receiving signals to detect the position of the magnet,
wherein the plurality of position sensors have different sections in which signals have linearity depending on the position of each position sensor.

12. The actuator according to claim 11,
wherein the control unit changes a position sensor being used to detect the position of the magnet with respect to a first position of the magnet.

13. The actuator according to claim 11,
wherein the plurality of position sensors includes a first position sensor and a second position sensor being disposed to be spaced apart in a first direction of the magnet.

14. The actuator according to claim 13,
wherein a signal of the first position sensor comprises a linear section and a non-linear section,
wherein a signal of the second position sensor comprises a linear section and a non-linear section,
wherein the linear section of the first position sensor and the linear section of the second position sensor do not coincide.

15. The actuator according to claim 14,
wherein the control unit changes the position sensor being used to detect the position of the magnet with respect to a center point of a point where the non-linear section of the first position sensor starts and a point where the non-linear section of the second position sensor starts.

16. The actuator according to claim 13,
wherein the control unit changes a position sensor being used to detect the position of the magnet with respect to the center point of an inflection point of a slope of a signal magnitude of the first position sensor and an inflection point of a signal magnitude of the second position sensor.

17. An actuator comprising:
a magnet;
a first position sensor being disposed facing the magnet;
a second position sensor being disposed facing the magnet and spaced apart from the first position sensor; and
a control unit being connected to the first position sensor and the second position sensor and receiving signals to detect the position of the magnet,
wherein the plurality of position sensors have different sections in which signals have linearity depending on the position of each position sensor.

18. The actuator according to claim 17,
wherein the first position sensor and the second position sensor are spaced apart from each other by a predetermined distance in a movement direction of the magnet.

19. The actuator according to claim 17,
wherein the control unit detects the position of the magnet by using a linear function being derived from the relationship between a signal of the first position sensor and a signal of the second position sensor.

20. The actuator according to claim 17,
wherein the linear function is a linear function being derived from a trigonometric relationship between a signal of the first position sensor and a signal of the second position sensor and the phase difference between a signal of the first position sensor and a signal of the second position sensor.
